(19) United States
(12) Patent Application Publication
(10) Pub. No.: US 2005/0240511 A1
(43) Pub. Date: Oct. 27, 2005

(54) Investment system

(76) Inventors: Christopher Nigel Peter Chadwick, Chalfont St. Giles (GB); Raglan Horatio Andrew Harold Tribe, Rowlands Castle (GB)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/939,476

(22) Filed: Sep. 14, 2004

(30) Foreign Application Priority Data
Apr. 23, 2004 (GB) 0409107.0

(51) Int. Cl. G06F 17/60

(52) U.S. Cl. 705/37

(57) ABSTRACT

An investment system for projects seeking funding, such as pre-trading enterprises, is disclosed. The system comprises a share allocation facility for allocating shares to a project on the basis of the funding that they require, and a stock exchange for trading shares in the project. During development of the project, the project is required to meet a number of development goals, and its progress through each of the development goals is audited. The results of the audit are published and may affect the share price in the project.

This invention relates to a method and system for the operation of a public stock and resource exchange for investment in pre-trading enterprises.

The capital markets have been huge enablers for technological advancement and investors in such enterprises have generally reaped excellent returns. However, spotting the potential early behind a good technological opportunity requires a high degree of specialisation that is usually beyond the reach of the average investor. Hence, traditional means for raising development capital for an enterprise often require the developer to show a good trading track record, so that investors have a reliable indication of potential. This is rarely possible for ground breaking technological opportunities.

The financial backing of early stage technology development is mainly down to the founders, family, friends and ‘angel’ investors. Appropriate expertise and legal protection is often omitted at this stage due to the lack of sufficient funds. Government grants help, but the support is limited and they often require further cash commitments to be made by the developers.

Venture capitalists often enter as the matters become desperate. Their funding is adequate but with preferred shares and ratchet clauses their capital comes at a heavy price for the original backers. Venture capitalists tend to drive the enterprise towards a short term and contrived exit strategy that helps drive the technological bandwagon, and allow them to maximize their returns. Hence the boom-bust swings that occur to the detriment of consistent technology investment. The criteria for backing technology has more to do with economic timing, than an expert assessment of the technology's potential.

We have therefore appreciated that it would be desirable to allow promising enterprises access to a stable and secure development fund, and to enable early stage, small investors to participate in the development of technological enterprises, whilst avoiding the risks and problems identified above.

A number of financial development systems are known. U.S. patent application 2003/0061139 for example, discloses a method and system for diversifying risk in privately-held stock. The system comprises a private trust which accepts donations of stock in exchange for trust units. The private trust is then managed to yield income for trust unit holders. As the private trust grows, the managed assets eventually reach a mass which permits an initial public offering (IPO) to be tendered to permit the trust to evolve into a close-end mutual fund. Public trading is then possible.

U.S. 2003/0014373 on the other hand discloses an automated system for matching business partners. The matching system incorporates a method enabling a presenter, such as a company seeking funding, to prepare a profile template. The profile template provides information parameters useful for a searcher, such as a venture capitalist, to make an initial partnering decision.

U.S. Pat. No. 6,629,082 provides a technique for an auction system that is used for pricing and allocating equity securities. The auction system employs a mathematical model that lets the market set a share price that is optimal for both the company and the purchasers of shares of stock in the company. This negates the traditional method of allowing entities such as investment bankers to negotiate the offering price, and better reflects what the market is truly willing to pay for the stock.

### SUMMARY OF THE INVENTION

The invention is defined in the independent claims to which reference should now be made. Advantageous features are set forth in the dependent claims.

An investment system for projects seeking funding, such as pre-trading enterprises, is provided. The system comprises a share allocation facility for allocating shares to a project on the basis of the funding that they require, and a share trading facility for trading shares in the project.

During development of the project, the project is required to meet a number of development goals, and its progress through each of the development goals is audited. The results of the audit are published and may affect the share price in the project.

### BRIEF DESCRIPTION OF THE DRAWINGS

The invention will now be described in more details, by way of example, and with respect to the drawings in which:

FIG. 1 is a schematic illustration of the development process from the perspective of a start-up business seeking funding;

FIG. 2 is a schematic illustration of the exchange community showing the interactions of the various role players;

FIG. 3 is a flow chart illustrating the life cycle of a project;

FIG. 4 is a flow chart illustrating the Automatic Concept Evaluation (ACE) and Automatic Project Planner (APP) stages of the project life cycle;

FIG. 5 is a mind map illustrating the concepts that are considered during the ACE and APP stages;

FIG. 6 illustrates a preferred graphical user interface providing a rapid development programme reckoner;

FIG. 7 illustrates a preferred graphical user interface for a rapid business case reckoner;

FIG. 8 illustrates a risk decision tree presenting the expected return on a project given different development scenarios;

FIG. 9 is an illustration of a preferred graphical user interface for entering a project idea definition;

FIG. 10 is an illustration of a graphical user interface for entering a market definition for a project;

FIG. 11 is an illustration of a scoring technique for assessing the strength of a project's proposal against competitor's enterprises;

FIG. 12 is a risk analysis form of the APP based on an example proposal;

FIG. 13 illustrates a risk analysis decision tree based on an example proposal;

FIG. 14 illustrates a project prospectus for an example proposal at the flotation stage;

FIG. 15 shows a user interface allowing users of the preferred system to access account, trading and resource booking applications; and

FIG. 16 shows an example web site of the preferred system.

### DESCRIPTION OF THE PREFERRED EMBODIMENT

The preferred embodiment of the invention provides a public stock trading and resource exchange system that enables investment in pre-trading technology development businesses or projects.

A pre-trading enterprise is understood to mean an enterprise committed to developing a product or service, which is seeking funding to cover development costs. A pre-trading enterprise will not yet have made an Initial Public Offering (IPO) of shares, such as a start-up venture, and may not even be an incorporated company, such as a theatre group developing a new production. A theatre group is considered trading once they are selling seats for their production for example. Any project seeking funding is therefore a candidate for the preferred system.

Finance is raised from small and large investors via the preferred embodiment by providing the following services:
(a) High quality public data that identifies new investment opportunities;
(b) Transparent pipeline development processes that allow investors to track project progress;
(c) Internet trading of project share holdings by public auctions;
(d) Automated systems that keep management charges low;
(e) Public financing for sound technology propositions;
(f) An entertaining and efficient investor experience similar to Internet gambling sites;
(g) Diversification of investment risk by allowing small holdings, portfolio spreads and real-time trading;
(h) Investment clubs that enable members to cheaply monitor technology developments, and which give them a first mover advantage;
(i) Exchange auditors that validate project deliverables at each phase exit on behalf of the investors.

These factors contribute to eliminate the risks involved with investing in new developments and therefore encourages positive investment returns.

The preferred embodiment takes the form of one or more software applications providing project registration, project share allocation, trading and accounting functions. A web site additionally provides user interfaces for project founders, investors and resource providers to communicate project proposals, provide instructions for transactions, agree contracts with resource providers and so on. Preferably, the web site provides a single portal from which individual user accounts, and all of the relevant functions of the back-end, software applications can be accessed. The home page of this single portal may then be used to display news relating to the investments or projects available, advertisements, and special offers.

The users of the stock trading and resource exchange system will form a sizeable community in which a number of different roles or purposes are represented. These are outlined in more detail below:
a) project founders, developers, entrepreneurs, inventors, innovators, or business start-ups submit project proposals to the community as opportunities for investment, in order to generate development funding for themselves;
b) investors provide development funding to project founders and in return receive a share in the profits if the project is successful;
c) resource providers provide expertise, advice, equipment or facilities to project founders so that they can progress the project, and to investors so that they can review their investment;
d) exchange operators regulate the stock trading and resource exchange system, making final decisions on the suitability of founders or resource providers to be admitted, as well as maintaining the necessary software infrastructure.

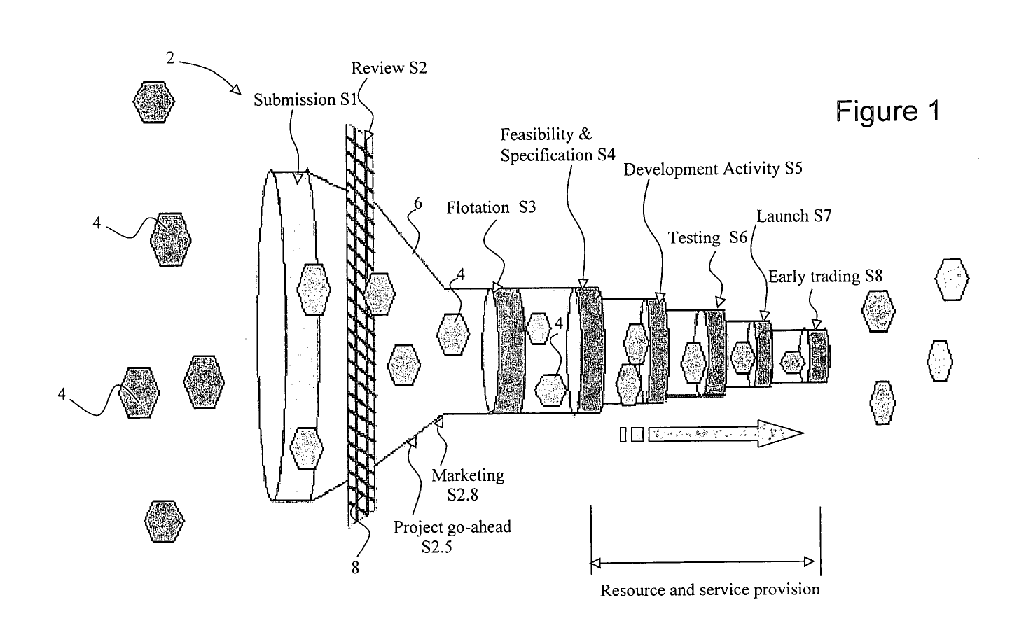

FIG. 1, to which reference should now be made, schematically illustrates an overview of the preferred system 2, from the perspective of a start-up business seeking funding.

New developments or projects 4 are submitted to a pipeline development process 6 by a project founder or developer in response to advertised market needs, or through their own initiative. The first stage of the process is to provide a formalised description of the project's goals and strategies. This is indicated at step S1. The definition preferably includes a project plan, the project exit, proposed intellectual property protection and likely financial benefits. The formalised definition is also required to include a list of business resources that are needed in order to support the project execution. Such resources include for example, accredited developments contractors, patent attorneys, laboratory facilities, manufacturing facilities and so on. These resources are made available to the founder or developer of the project by the resource exchange aspect of the system and can be booked by him during the development process.

The submissions put forward by project founders are subjected to a two-stage review process. The first of these, indicated in step S2, shall be referred to as a self screening ready reckoner process. This takes the form of an interactive web page which allocates a score to the information provided by the project founder, giving an indication of the likelihood that the project will be accepted by the exchange. The project founder can amend and improve his submission using the ready-reckoner until the score indicates that the project is likely to be accepted formally into the development pipeline. At this stage, the submission is formally transmitted to the pipeline where it is subjected to a second review process in which the feasibility and likely benefit of the project is confirmed by an exchange operator in conjunction possibly with one or more resource providers, such as auditors, accountants, and intellectual property specialists.

It will be appreciated that not all of the projects submitted to the pipeline will be approved by the review process. FIG. 1 illustrates this schematically by means of the filter 8 shown in the pipeline.

Following the review process S2, a project which is approved in step S2.5 is then marketed to the exchange community in step S2.8. Marketing may involve a variety of promotional means, such as advertisement on the dedicated web site, by e-mail or conventional mail shots, or any other known advertising method.

The exchange ascribes shares to the project according to the total amount of funding capital that is required. These shares are offered to the public, preferably via the web site, in flotation step S3. In the flotation process S3, the public can become investors by reserving shares in the venture, and by committing an appropriate amount of the capital.

These functions are performed by the share allocation facility of the preferred system. The facility will be understood to comprise the necessary software and protocols to allocate shares in a project given an amount of funding that is desired. The facility may also comprise means to publish information offering the shares for sale, and for reserving shares in response to bids for shares from investors. Implementation of such software and protocols will be understood by those skilled in the art and so will not be further explained here.

Once sufficient capital has been subscribed to fully finance the project from start to completion, the project founder is allowed to proceed and actually begin work on the development. Preferably, the project is executed in a number of stages, each of which is subjected to public review and an end-stage review by a resource provider, such as an auditor, who decides whether the project will continue to the next stage. The funding from those investors who have reserved shares is released in tranches at the beginning of each subsequent stage. Thus, after successfully completing the flotation, only the first tranche of funding is released to the project founder. Should the project fail to progress to the next development stage, no further stages of funding are released. This money can be returned to the investor thus limiting the investor's losses.

If insufficient funding is generated in the flotation process from the sale of shares to finance the entire development process, the project is not continued with and any commitments to buy shares are cancelled. In this way, capital pledged by investors is only debited from their accounts once shares in a project are fully subscribed.

Preferably, the stages of development process follow a prescribed pattern for each project. The stages are S4 ‘feasibility and specification’, S5 ‘development activity’, S6 ‘testing’, S7 ‘launch and support’ and S8 ‘early trading’. The purpose of these stages is evident from each of the stage titles, and they will not therefore be described in detail here.

It will be appreciated that during those development stages, the auditor's reports which are made public by means of the dedicated web site and other media may affect the value of shares in the project. These shares can therefore be traded at any time during the development process. To guide investors, the trading system automatically computes average buy and sell prices based on transaction averages. Further guidance can also be accessed from subscription analyst reports. Investors can also set up trading rules for automatic trading.

Once the project has achieved its defined exit after step S8, all trading stops and the shareholders account will be credited with the project exit's financial returns. In its entirety, the trading and investing process requires no underwriters or market makers, thereby keeping the management fees payable by the investors low.

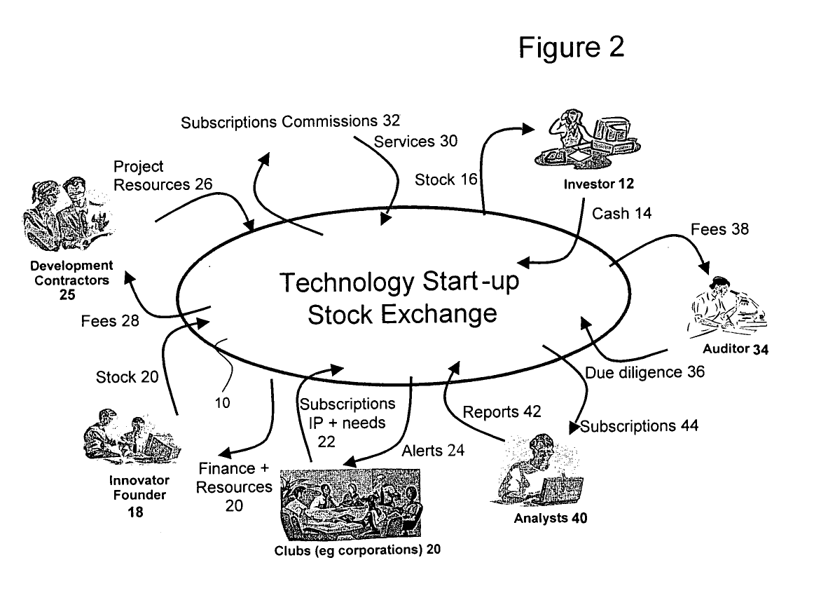

The roles of those interacting with the exchange will now be described in more detail with reference to FIG. 2. In FIG. 2, the framework of software applications and development protocols which form the core of the exchange are represented as a ‘technology start-up stock exchange’ 10. As described earlier, the principal role players are investors 12 who invest funds 14 in return for stock 16, and project founders or innovators 18 who submit projects and exchange stock 20 for finance and resources 22. Other role players are club members 20, such as corporations, who may submit requests for intellectual property or market needs 22, and who may receive alerts 24 notifying them of proposals put forward and of any developments. It will be appreciated that the requests published by the club members 20 may be made available to prospective innovators or project founders 18 in order to attract project development in particular areas.

Various resource providers provide services or expertise to the technology start-up stock exchange 10. Development contractors 25 for example, may provide project resources 26, such as manufacturing facilities, laboratory time, testing facilities and so on, in return for fees 28. Additionally, patent attorneys or other intellectual property resource specialists may provide services 30, resources or intellectual property in return for payment and in response to subscriptions or commissions 32.

Exchange auditors 34 are employed to audit the deliverables of each project at each phase or stage review on behalf of the public, and provide a due diligence report 36 in return for their professional fees 38. Lastly, accredited analysts 40 may be employed to provide paid-for or free information 42 to guide investors. Investors may also subscribe to the analyst reports by subscriptions 44.

Preferably, the system comprises a database of auditors and other resource providers so that suitable providers of services can be searched for as a demand for them arises.

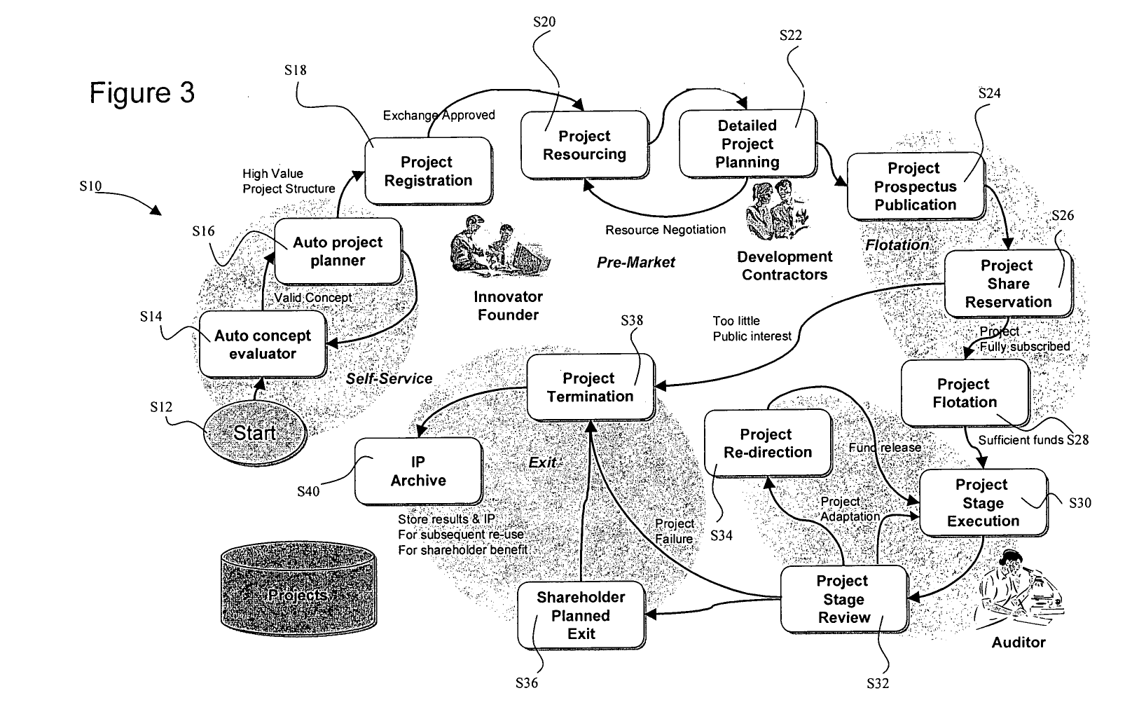

The operation of the preferred system will now be described in more detail with reference to FIG. 3, which schematically shows the life cycle of a project from start to finish.

An innovator or project founder begins in step S10, by logging onto the dedicated web site (start step S12). In step S14 the web site presents an Internet form, which shall be referred to as the ‘Automatic Concept Evaluator’ (ACE). The ACE invites the founder to fill in responses to a series of questions about the project idea, covering such aspects as the market potential, the technical feasibility, the financial investments and returns, operational matters and investment exit opportunities. From these answers, the ACE calculates an investment potential score and compares this with a predetermined threshold. Scores above the threshold indicate that the founder is likely to have a valid project for investment. In this case, the founder is directed to further pages of the web site in order to complete the next evaluation stage. In the ACE process, psychometric techniques may be used to assess the founder's sincerity by asking identical questions in different ways, so that consistency can be assessed. This allows bogus entries to be screened out at an early stage.

Investment potential scores below the predetermined threshold indicate that the project described by the founder is not likely to be a viable project for investment, or that the founder has not yet given the project sufficient thought and planning. In this case, the web site may direct the founder back to the start step S12, or may simply allow the founder to fill in the Internet form for a subsequent try.

If the concept presented by the founder is evaluated in step S14 as a valid concept, control flows to step S16 where subsequent interactive pages of the web site present an Automatic Project Planner (APP). It will be appreciated that typically, the stock exchange will be seeking projects with a high marketing and development certainty, but also those with high breakthrough technical risks as these projects often earn the most value for the shareholders. However, it is essential that the technical risks be evaluated cheaply and early on in the project execution so that any risk to the investor can be properly measured. Furthermore, it is even more important for the development of projects of this type to be correctly structured, so that the investment return can be optimised during execution of the project. These considerations are addressed by the APP.

The APP S16 therefore consists of an expert system planner and decision tree builder, allowing the project plans to be optimised by the founder and achieve the maximum Expected Net Present Value or E(NPV). The APP S16 allows the founder to calculate an expected project value based on a reasoned calculation of the investment required and the risks likely to be met. If the expected project value exceeds a certain threshold, then the project is identified as one which is likely to be of interest to investors in the exchange. In this case, control flows to step S18 where the project details are registered with the exchange and passed to an exchange operator who may then arrange a meeting with the founder in order to take the project forward.

If the expected value of the project is insufficient to merit interest by members of the exchange, the Automatic Project Planner returns to the Automatic Concept Evaluator step S14 so that the project founder can re-evaluate the project.

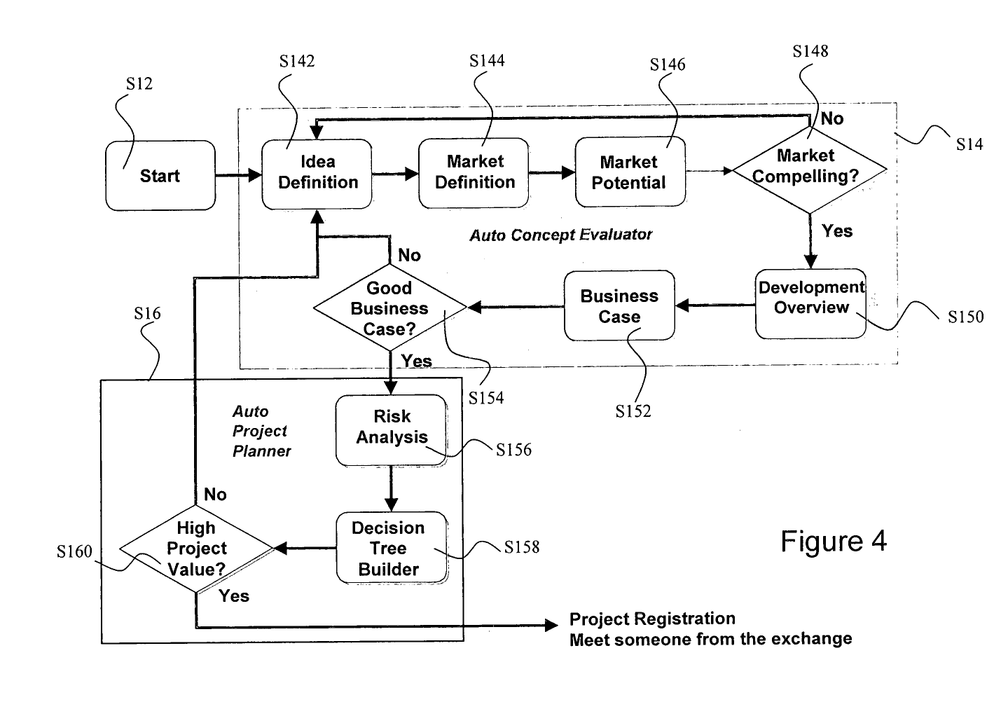

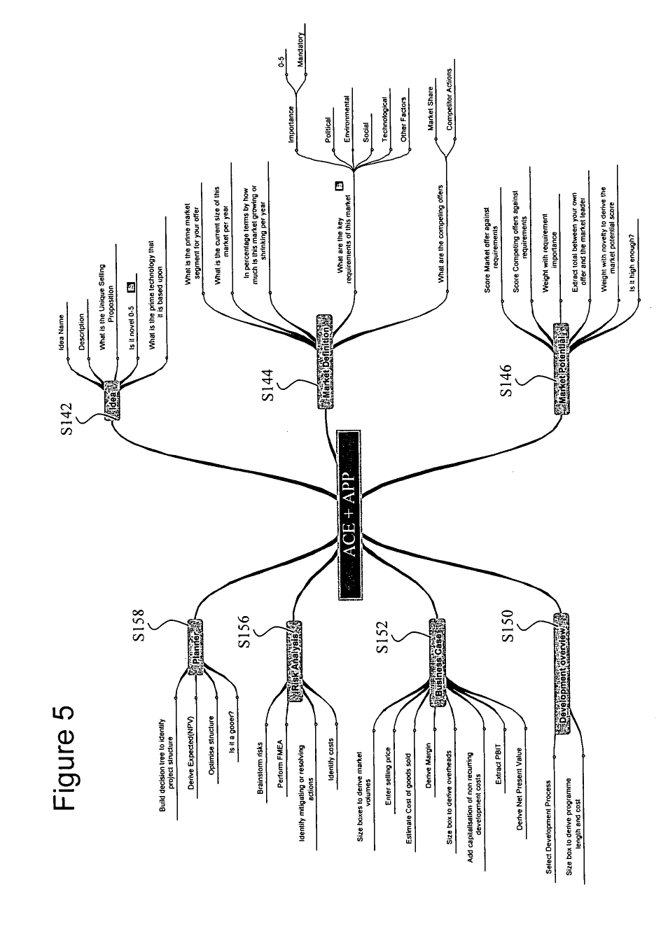

The Automatic Concept Evaluator process S14 and the Automatic Project Planner process will now be described in more detail with reference to FIGS. 4 and 5. The ACE and APP will be understood to form the self-screening ready reckoner mentioned earlier in the review step S2 of FIG. 1.

FIG. 4 is a flowchart illustrating in more detail, steps S12, S14, S16 and S18 of FIG. 3. FIG. 5 is a mind map showing the considerations at each stage in the process.

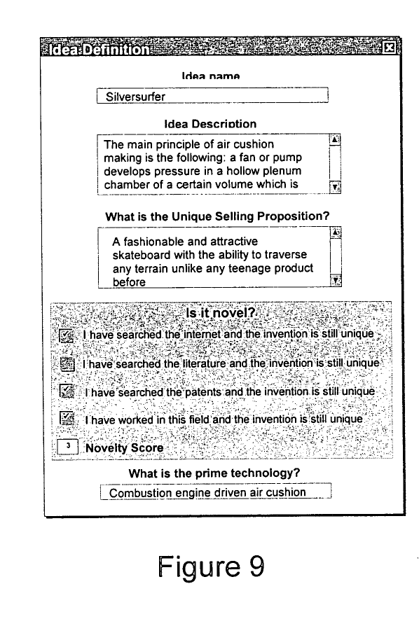

Following start step S12, the first input required from the project founder by Automatic Concept Evaluator S14 is an idea definition. This is represented as step S142 in FIG. 4. As shown in FIG. 5, the idea definition may comprise an idea name, a general description, a summary of the unique selling proposition, a novelty score on a scale of 0-5 of the novelty of the proposal, and a description of the prime technology that the project is based upon. A completed idea definition form is shown later in FIG. 9 for a particular example project.

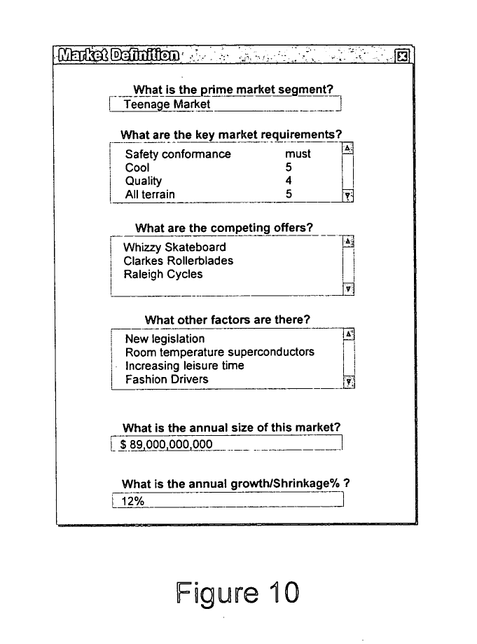

Having completed the input for this stage, the founder proceeds to step S144 where he is invited to enter a definition of the market for the project. As shown in FIG. 5, this preferably involves defining the prime market segment for the founders offer, and the percentage change in the size of the market segment per year. The market definition preferably also involves information about the key requirements of the market, and their importance rated on a scale of 0 to 5. Some of the requirements may be defined as mandatory. Political, environmental, social and technological considerations, as well as any other factors, may also be listed. The market definition also preferably requires that the project founder enter information about competing products, such as the market share held by any competitors, and the current activities of those competitors in the market. A completed market definition screen is also shown later, in FIG. 10.

It will be appreciated that failure by a founder to adequately complete the market definition section of the ACE may indicate that he has not conducted sufficient research into the likelihood of his project being viable in the present market. In these circumstances, the score given to the project by the Automatic Concept Evaluator is likely to be low.

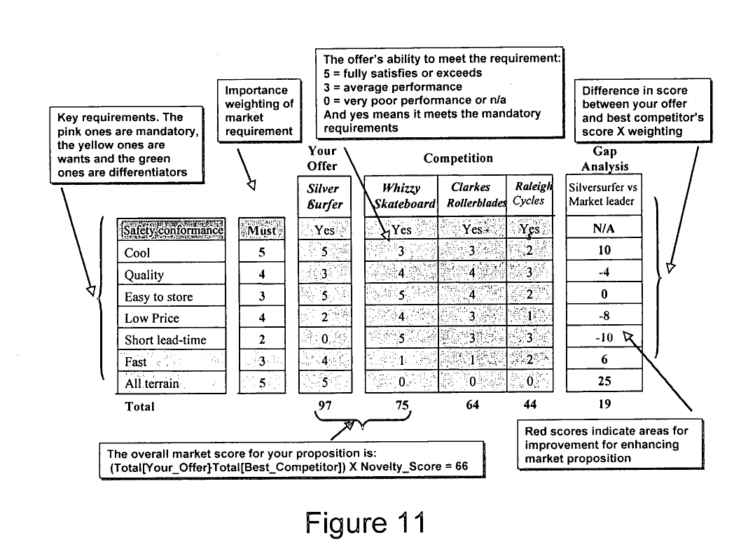

Following completion of the market definition section S144, the founder may proceed to step S146 where an assessment of market potential is required. In particular, the project founder is asked to identify the key requirements of the market, such as safety, appeal, quality and so on. The Automatic Concept Evaluator may also suggest generic requirements or more specific requirements based on the founder's definition of the market. A founder is then requested to give a score to his proposal and any competing products based on the market requirements that have been identified. FIG. 11 shows an example of this stage in the Automatic Concept Evaluator for a particular example project to be described later.

Weighting may be applied to each of the respective requirements in order to express their importance. It is also preferred if the requirements are separated into different categories, such as a mandatory category, a desirable category and a differentiating category. The Automatic Concept Evaluator evaluates the proposal on the basis of the scores input by the founder for both his proposal and the products of the competitors. A breakdown of the score is given for each of the requirements he has identified so that he may easily see where the strengths and weaknesses of his proposal lie. Also, an overall market score for the proposal is calculated on the basis of a predetermined equation.

Following this stage, the overall market score for the proposal is evaluated against a threshold (step 148). If the score is not found to lie above the threshold, then the project founder is returned to the idea definition input stage 142 and invited to fill in the Internet form again. If the score is above the threshold, however, then the Automatic Concept Evaluation process continues and control flows to step S150 where the founder is required to enter details of the development overview for the project.

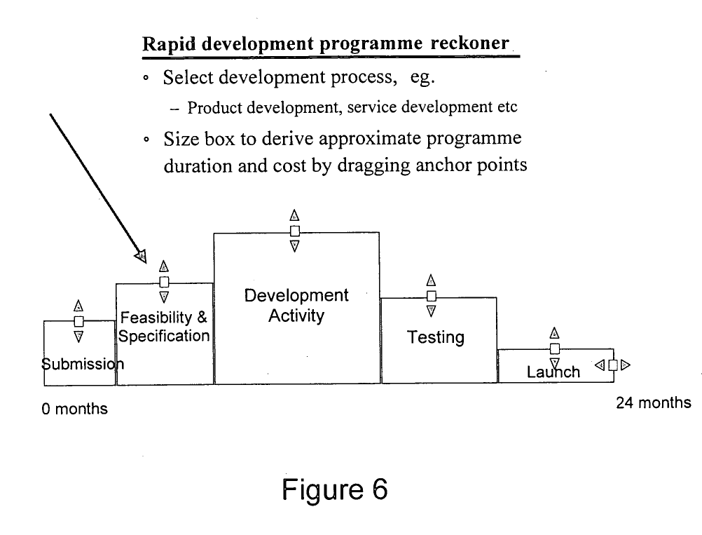

The graphical user interface for the development overview phase presents the founder with a chart allowing him to indicate the amount of time and funding he expects will be necessary for each stage of the development process. This is shown in FIG. 6. It is assumed that the project development will take about two years to complete, but longer projects may be possible. Rectangular boxes are shown, each representing one of the submission S1, feasibility and specification S4, development activity S5, testing S6, and launch S7 stages. The width of the rectangles, corresponding to time shown on a time axis, may be sized in order to indicate how much of the development time the founder anticipates spending on each stage. Additionally, the height of the rectangle may be adjusted to indicate the relative cost expected in order to complete that stage of the development.

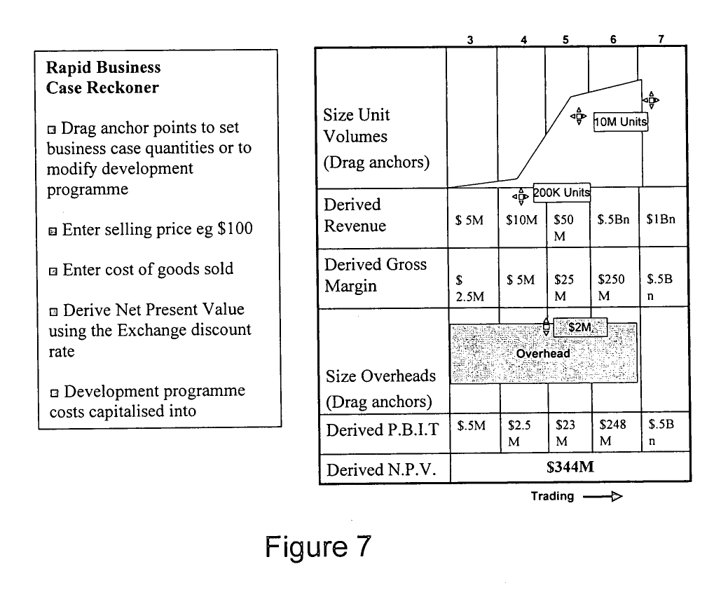

Following the input of the development overview information in step S150, the project founder is invited in step S152 to provide information about the business case for the project. A graphical user interface such as that shown in FIG. 7 is presented to the project founder in order to facilitate this process. The graphical user interface comprises a number of columns corresponding to years of sale following completion of the development process. In FIG. 7, the first year shown is year 3, as it is assumed that years 1 and 2 are spent developing the project before its launch. The first row of the interface allows the founder to input predicted sales over a number of years. This is achieved using a dragable plot line to indicate the fluctuation of sales over time. On rows two and three of the graphical user interface the derived revenue from sales is input for each year, as is the derived gross margin obtained. In the fourth row of the interface, the project founder can input the expenditure on overheads over the years of sale. Again, a dragable plotline is provided for this row to make the process easier.

Once the first four rows of this table have been completed, a software process of the Automatic Concept Evaluator calculates the derived profit before interest and tax (PBIT) and enters this into the fifth row of the table, and calculates the derived net present value (NPV) and inputs this into the last row of the table.

The net present value calculated is then compared against a threshold value chosen to indicate the minimum level of return required for the exchange to have interest in the project. The check is performed in step S154. If the calculated net present value is lower than the threshold, then it is determined that the project founder has not yet made a good business case for investment. Control then flows from step S154 back to step S142 returning to the beginning of the Automatic Concept Evaluator process. The project founder then has the option of completing another Automatic Content Evaluation form and strengthen his project proposal.

If in step S154 however the estimated net present value is above the desired threshold, then control flows to step S156 which is the first step in the Automatic Project Planner process S16.

In step S156, the project founder is presented with an Internet form requiring him to identify risks which would hinder or prevent the project from being carried through to completion. The founder is invited to list each of these risks in a new row of a table, and estimate the probability or likelihood of each risk being encountered. In addition, the founder is required to indicate the severity of the risk occurring on a scale of 0 to 10. The APP then calculates an impact score, which is the product of the likelihood and severity, and which allows the different risks to be compared.

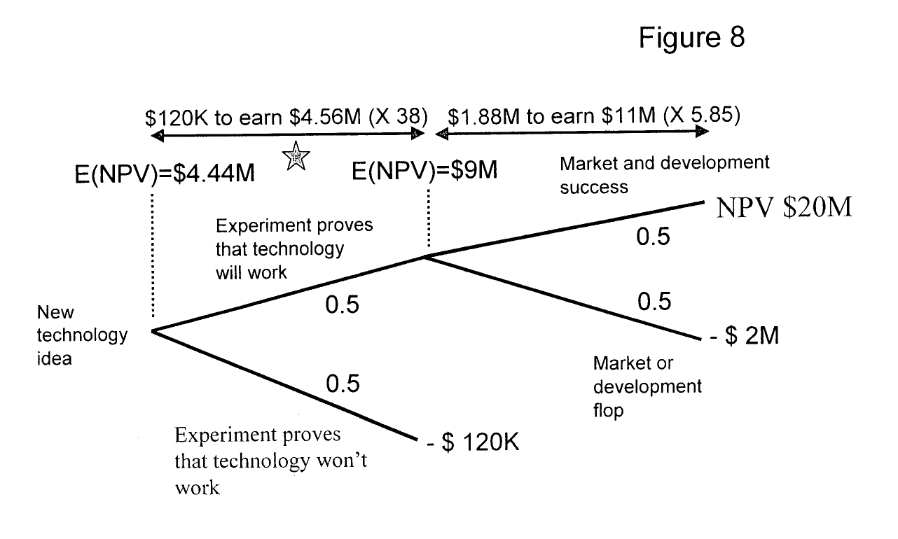

Additionally, the project founder is required to add, for each risk that is identified, a mitigating or resolving action to take should that risk be encountered, and also the likely cost of taking that action should the risk occur. By requiring that the project founder fill in this table therefore, the stock exchange mechanism ensures that the founder has given adequate thought to the project development and that they have made sufficient contingency plans in case things should go wrong. Having completed this form, control then passes from step S156 to step S158 where the project founder is presented with a project decision tree builder requiring completion. An example decision tree is shown in FIG. 8, to which reference should now be made. The project decision tree shown in FIG. 8 is a conventional probability tree which allows a branch to be inserted for each risk identified in the risk analysis form completed in step S156. For each branch of the tree the probability of that outcome occurring is indicated. Furthermore, at each node of the tree the expected net present value is indicated, taking into account the total net present value if the project continues unhindered as well as reduced net preset valued if action to remedy problems is required.

The project decision tree therefore provides investors with a plan showing the expected returns and the risks for a particular project during the development process as it progresses through the development processes. The project decision tree will therefore be useful for investors who wish to buy or sell their shares in a particular project as it enables them to weigh the likely risks against a likely return at any stage in the project and in particular at the point of time when they are buying or selling the shares. The cost of each outcome is also indicated on the relevant branches of the tree so that any financial penalties of failure at a particular stage can be assessed.

Following completion of the decision tree builder in step S158, control flows to step S160 where the expected net present value for the total project is again compared to a threshold value. This expected net present value will be different to that calculated in step S152 for the business case, as it will now factor in the cost of the risks involved.

If the expected net present value is less than a required threshold value control flows back once again to the idea definition stage step 142 of the Automatic Concept Evaluator for the project founder to complete another assessment form. However, if at this stage the expected net present value is above the threshold value, then the project will be identified as one with a high value and control will flow to step S18 in which the project is registered and the project founder is invited to meet someone from the exchange to discuss taking the project forward.

The registration process is confidential and preferably includes a face-to-face interview with a member of the exchange, followed up with due diligence exercises and securing of any intellectual property rights. The cost of these stages should be nominal in comparison to the likely return, given investment in the project. It is preferable therefore if these costs are borne by the founder as it will demonstrate founder commitment to the venture.

If the exchange member approves the project, then auditors will be appointed to carry out the phase review of each development stage shown in FIG. 1. The founder then proceeds to detailed project planning.

To illustrate the steps of the Automatic Concept Evaluator and the Automatic Project Planner in more detail, use of the self-screening ready reckoner of the preferred system by a fictitious enterprise will now be described in detail. For the fictitious enterprise we shall take a company called Hoverboard Ltd, who have produced a new product, the “Silversurfer”, a surfboard with hovercraft properties that flies six inches above the ground or water. Hoverboard have also developed new technology in the form of a turbo-fan which, when combined with the latest lightweight motors, produces enough uplift to carry an adult male at speeds of up to 20 mph.

At present, Hoverboard Ltd are only at the concept stage regarding the Silversurfer. A prototype has not been produced and the market has not been tested. Patent protection for their turbo fan has however been applied for and market research into competitors and product requirements has been conducted. They now need finance to develop a fully functioning prototype, to test the concept and to enter early stage production.

Hoverboard Ltd's founder, Jeff Dodds, logs onto the dedicated web site provided by the preferred system via a personal computer or similar access device. The web site leads him through an explanation of the relevance of the business exchange to start-ups and also through the application process. He decides to proceed and the web site leads him to ACE, the Auto Concept Evaluator, which enables him to determine whether his concept is strong enough to be considered for financing by means of a share flotation on the exchange. ACE requires Hoverboard to have a good understanding not just of their Silversurfer product, but also of the competitive environment in which it will be launched.

The first Internet form presented to Jeff Dodds via the ACE sight is the idea definition form (step S142). A preferred version of the form, with Jeff Dodds' input, is shown in FIG. 9.

The idea definition form comprises a number of fields in which text can be entered. Fields are provided for an idea name, an idea description, a description of the unique selling properties and the prime technology to be utilised. In the idea name field, Jeff Dodds enters the proposed name of the project “Silversurfer”. In the idea description box he enters text describing production of an air cushion in typical hovercrafts and, for the unique selling proposition, he enters one or two sentences describing the appeal of the product. These fields are designed to include scroll bars should he wish to add more text than can be shown in the fixed size box of the form. The idea definition form also comprises a number of radio buttons designed to assess the novelty of the idea. Each of these radio buttons indicates a different level of searching that the project founder may have carried out. By clicking a button, the founder declares that he has carried out that extent of searching and still believes that his idea is unique. Based on the number of buttons he ticks a novelty score is allocated to his idea. In the example shown a score of three is allocated because three boxes have been ticked. However, it may be the case that certain of the searches have more importance than others. In this case, weighting or multiplication factors may be used to amplify the score from a particular box.

In the prime technology field, Jeff Dodds indicates that a combustion engine driven air cushion is the technology relied upon.

Having completed this form, the ACE presents the market definition form to Jeff Dodds in step S144. This comprises further fields requiring input. The form, with Jeff Dodds' input is shown in FIG. 10. Jeff Dodds indicates that the prime market segment will be the teenage market, and moves on to the subsequent field identifying the key market requirements. In this case, he lists a number of factors, such as safety conformance, whether it is “cool”, its quality, and its ability to handle all terrains. He identifies the importance of each of these factors by inputting a weighting factor, either a “must” or a number on a scale of 1 to 5.

In the subsequent field of the form he indicates competing products of which he is aware. These include a brand of conventional skateboard, as well as roller blades and bicycles by well known manufacturers. In the next field of the form he indicates other factors that may be relevant to the project's development, such as the need for new legislation, technical and safety considerations of room temperature super conductors, considerations of increasing leisure time, and factors that may drive markets. In the last two fields of the form Jeff Dodds indicates that the expected annual size of the market will be $89 billion and that the annual growth of the market is 12%.

Having completed this form, the Automatic Concept Evaluator processes the data and presents a new form for completion. This is shown in FIG. 11, to which reference should now be made.

FIG. 11 shows a table in which the Silversurfer product proposed by Jeff Dodds is evaluated and compared against the competitors that were outlined in the market definition section. It will be appreciated that the ACE interface may be implemented to automatically copy the details from the idea definition and market definition forms into this table at the relevant position. Alternatively, Jeff Dodds may be invited to re-input some of the data. The first column of the table lists the key market requirements Jeff Dodds input in the market definition form. The next column shows the weighting factor he gave to each of these.

In the third column of the table, Jeff Dodds enters his scores for his Silversurfer proposal for each of the market requirements he has identified, and in the next three columns he does the same for each of the competing products he considered. The final column of the table shows an overall score for each requirement, comparing the Silversurfer product to the leading market competitor and taking the weighting factor into account. For example, on the second row of the table, which shows whether or not the product is likely to be perceived as “cool” by the market audience, the Silversurfer scores a 5. The weighting factor for this row is also 5, which means that the product of the Silversurfer score and the weighting factor equals 25 points. By comparison, the closest competing product, in this case either the Whizzy skateboard or the roller blades, score 3 points. When multiplied by the weighting factor, both of these competitors achieve a score of 15. The difference between the two is therefore 10 and this figure is shown in the final column, ‘gap analysis’. For each key requirement therefore a score is calculated based on the weighting factor showing Jeff Dodd's product strengths and weaknesses.

For the first row of the table, the weighting factor shown is “must”. No score is therefore calculated, as instead of a score a ‘yes’ or ‘no’ value is assigned to each product.

The total scores, the sum of those for each of the key requirements, is also shown in the bottom row of the table for the Silversurfer and each competitor.

The ACE generates an overall market score for the Silversurfer using this table. This is calculated by subtracting the total score for the best market competitor from the total score for the Silversurfer product, and multiplying that difference by the novelty score calculated from the idea definition form. In the present case, the difference between the Silversurfer score and that of its nearest competitor, the Whizzy skateboard, is 22 points. The novelty score from the idea definition page was 3 points, giving an overall market score of 66. An overall market score of 50 or above may be required by the ACE for Jeff Dodds to continue to the next stage. 66 is a passing score and Jeff Dodds wipes his brow with relief. He then moves on to the development overview part of the ACE described in connection with step S150 and step S152, and with reference to FIGS. 6 and 7.

The Rapid Development Program-Reckoner shown in FIG. 6 is a shortcut routine to determine the time and cost of the development process stages. The drag anchor points make it easy for Dodds to scope the size of the program. Similarly, the business case reckoner interface shown in FIG. 7, enables Dodds to input key variables such as the selling price and estimated sales, allowing a calculation to be made of a theoretical profit before interest and tax, as well as a figure for the net present value of the project. This is estimated at $344 million.

Providing this figure is above a threshold value of say $250 million, the ACE allows Jeff Dodds to proceed to the next stage of the Automatic Planning Program. Having worked out that the project is potentially highly profitable, Jeff Dodds now needs to understand the risks associated with the project, and importantly how these can be minimised. The risk analysis section and the decision tree builder interfaces of the Automatic Project Planner allow Jeff Dodds to do this.

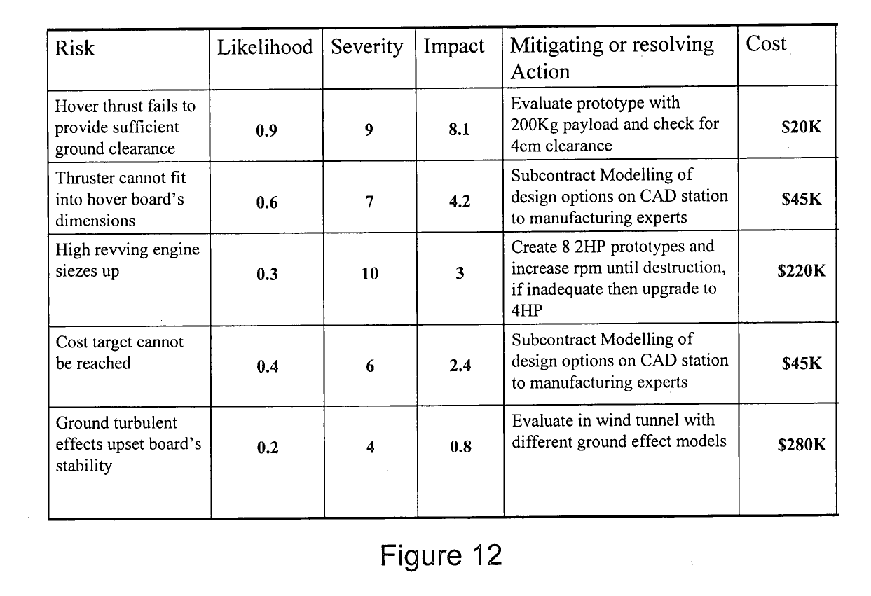

Referring to the risk analysis form shown in FIG. 12, Jeff Dodds identifies a number of risks that may prevent successful completion of his project. One risk is that the thrust provided by the Silversurfer fails to provide sufficient ground clearance. Additional identified risks are that the thruster cannot fit into the Silversurfer's dimensions; that at high revs the engine seizes up; that the cost target may not be reached; and that ground turbulence effects may upset the board's operation. For each of these risks Jeff Dodds scores the likelihood of the risk occurring. For example, a score of 0.4 is understood to correspond to a probability of 40%. The likelihoods are shown in a column adjacent to the identified risks. He then indicates the risk severity, that is to say the perceived consequences of the event happening, on a scale of 1 to 10. The most significant risk for example as indicated by Jeff Dodds with a score of 10 is that at high revs the engine seizes up. The ACE interface then calculates the scores for the adjacent ‘Impact’ column by multiplying the score for the likelihood with the score for the severity of each risk. By following this procedure, Dodds works out that the most significant risk in terms of impact is the possibility of the hover thrust failing to provide sufficient ground clearance.

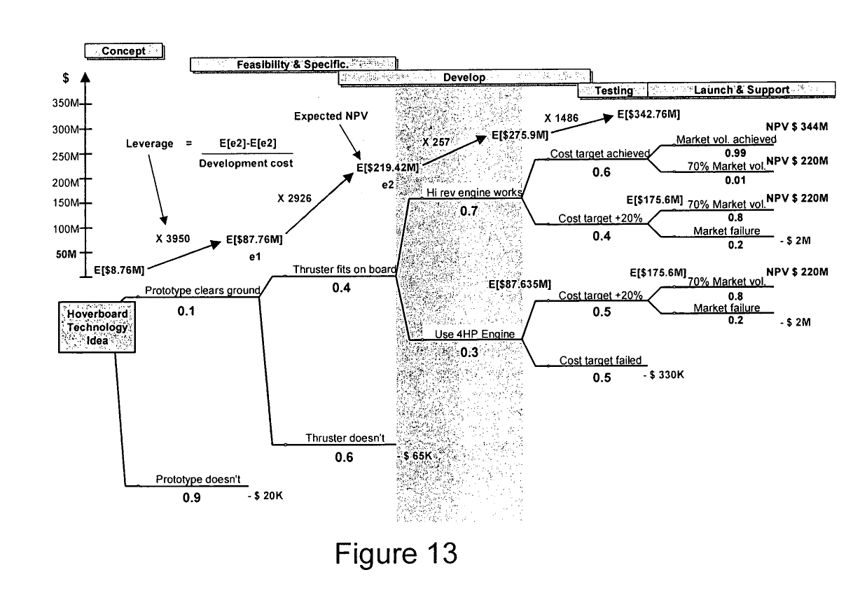

Having determined the highest risk in order of impact, Jeff Dodds now anticipates what action would be required to mitigate the various risks, together with the cost of doing so. For instance, the cost of resolving the risk of realising insufficient thrust is anticipated to be $20,000. The cost of resolving the issue of ground turbulence however is estimated to be higher at $280,000. This analysis is fundamental, because if the enterprise can address significant, but relatively cheap-to-resolve risks at an early stage in the development cycle, then investor value is significantly boosted as projects can be aborted early, saving unnecessary investment money. Having completed this form, the Automatic Project Planner generates a decision tree builder, shown in FIG. 13 from the information entered in the previous stages of risk analysis and of the ACE process. The risk decision tree is critical to Jeff Dodds and his potential investors alike as the chart provides a mathematically derived investment value for the Silversurfer at each stage of the development cycle before any development work has actually been carried out. The chart shows the net present value of $344 million after the launch date assuming that the project goes smoothly, namely all the assumptions made materialise, and all the technical risks can be avoided. It also however, shows the net present value if the market and cost assumptions are not met, and if adverse situations are encountered. By multiplying the net present value by the risk likelihood factors at each stage of development, Jeff Dodds can determine the project's expected net present value (ENPV) at the start of the process, or at any particular point in time. At the start of the process the net present value of the project is only $8.76 million, but as each stage is successfully completed the net present value increases. These figures are a critical figure for potential investors in deciding whether or not the Silversurfer looks a good bet for their money.

What the chart also shows is that there is a very high risk of the prototype Silversurfer not being able to maintain sufficient ground clearance. However, if this were the case, investors would only lose $20,000 of their money should the project be aborted. The remaining sum, $1.98 million, would then be returned to them.

Having determined the likely financial outcome scenarios for the Silversurfer, Jeff Dodds knows that he has a compelling case for financing from the stock exchange. The Automatic Project Planner verifies this and then completes forwarding his details on to an exchange member. This member will arrange a meeting to discuss the project further with Dodds. The self-screening phase is now over and the project registration, resourcing and detailed planning steps shown in FIG. 3 are completed. The subsequent steps shown in FIG. 3 will now be described in more detail.

In step 18 of FIG. 3, the project founder who has made a successful application, Jeff Dodds for example, is invited to meet a representative of the Stock Exchange. Before the initial meeting, the representative of the Stock exchange will have received Jeff Dodds' proposals submitted via the automatic concept evaluation and automatic project planning stages. The representative may therefore, before the meeting, check Jeff Dodds' calculations and figures and may commission further investigations by members of the exchange into the markets and technology identified. Assuming the representative is satisfied by the accuracy and the viability of the proposal, the initial meeting will go ahead. At this meeting Jeff Dodds will be required to explain how he plans to take the project forward, disclose any relevant intellectual property that has been secured, such as patent applications, for example, and indicate what resources he is likely to need to complete the development process. The representative of the Stock Exchange may involve other personnel, such as patent attorneys or technical advisers at this initial meeting in order to facilitate the planning process.

The Exchange facilitates the booking of accredited exchange contractors or other resources, the settling of contracts, and the downstream payments by means of an account management system. Jeff Dodds can therefore negotiate whatever resources he needs, such as testing equipment to evaluate the thrust provided by the Silversurfer, expertise to model the dimensions of the board or time in a wind tunnel to evaluate the final board's performance, and secure these against the promise of payment once funds have been generated in the flotation process.

Jeff Dodds and Hoverboard Limited now have the confidence and a detailed plan in order to go to the market for funds via flotation on the Stock Exchange. The next stage is therefore to raise capital and this is achieved in step S24 of FIG. 3 by producing a project publication for advertisement to the Stock Exchange members. It will be appreciated that the advertisement may be via the dedicated web site, or by mail or e-mail. Furthermore, exchange members who have opted to receive project promotions may be alerted by e-mail, mobile phone text messages, bulletin boards, direct mail or by ordinary phone calls. Outstanding opportunities for investment could also be advertised via television promotions or other known form of advertising.

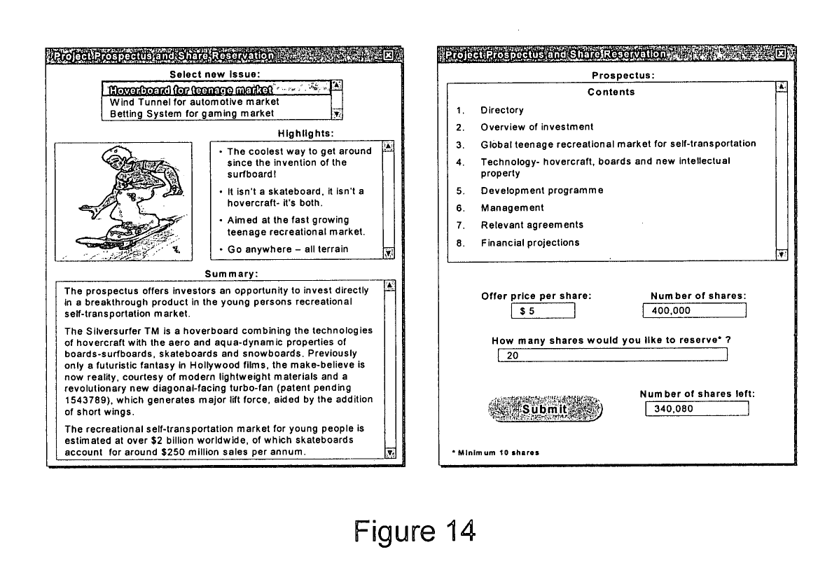

A proposed publication for Jeff Dodds' Silversurfer product is shown in FIG. 14 as it might appear displayed on a web page of the stock exchange. In addition to the summary of the product, and the development and technical plans developed in the earlier stages, the web site shows a number of shares and an offer price per share. In the present case 4000 shares are potentially available at an offer price of $5 each, to general funding capital of $20,000. The number and the price of shares necessary to finance the project will be calculated on the basis of the funds required by Jeff Dodds in order to take the project through to completion. It will be appreciated that this figure will also flow out of discussions and negotiations with the Exchange representative, as at this stage additional resources may be booked and will therefore ultimately need paying for. The amount of funding is therefore likely to be different to that estimated by the project funder and should be confirmed before the flotation stage.

Once the publication has been made in step S24, the project formally enters the flotation stage. After publication in step S26 members of the Stock Exchange can reserve shares in the project by committing funds from their account. It will be appreciated that shares can be booked by mobile phone messaging, dedicated options accessed through a television set-top box, by e-mailing a dedicated e-mail account at the Stock Exchange or by utilising dedicated web pages on the Stock Exchange site. The web site tracks the amount of shares that have been reserved and the amount of money pledged. Until all of the shares have been sold, sufficient funding to support the project has not been generated. The web site therefore tracks the amount of shares that have been sold and only once the offer is fully subscribed are all the funds committed to the project and the investor's account debited. In this case, control flows to step S28 and the founder is notified of the successful flotation. The first phase of funds in order to complete the development activity phase S4 are then released to him.

If however, sufficient funds are not generated by the project share reservation stage S26, then the project is terminated and control flows to step S38. The project will not then be continued with and the project founder will need to look elsewhere for funding. However, any intellectual property generated by the involvement of the Stock Exchange is retained in step S40 for subsequent re-use and shareholder benefit. Step S40 represents storage of this intellectual property in an intellectual property archive.

The approach described above saves the cost of having flotation underwriters. However, if the founder wishes, then insurance underwriting could be sought prior to flotation.

Assuming that the flotation is successful, control flows to step S30 and the first tranche of funds from the flotation are released to the founder. The project now cycles through the standard phase reviews specified in the development process, namely a feasibility and specification phase S4, a development activity phase S5, a testing phase S6, a launch and support phase S7, and an early trading phase S8.

After each phase there is a stage review held at step S32. An auditor from the Stock Exchange validates the project deliverables. If the auditor approves the progress of the project, he digitally signs off the project to proceed to the next stage of execution. The sign-off automatically releases the next phase of funds into the founder's account, and the founder can then sign-off the release of funds into sub-contractors or resource provider accounts where appropriate. Control therefore flows between step S32 and S30 until all of the stages are completed.

If however, the auditor is not satisfied with the progress of the project and does not believe that it will deliver the expected outcome, then he may choose to cancel the project at any of the project stage reviews S32. In this case the project is terminated and control flows to step S38. If not successful, the shareholders are notified of the project's failure and the remaining funds are returned to the shareholders.

Alternatively, redirection of the project plan or modification in some way may be possible. For example, if the project founder encountered an unforeseen problem which required further investigation. Redirection would be at the auditor's discretion, and is likely to be allowed in cases where additional shareholder benefit had been found at no extra cost, or because the project had partly succeeded and because redirection would mitigate accrued losses and would be unlikely to lead to any further losses.

Throughout the project execution, shares in the project can be traded through the Exchange's auction system. This forms part of a share trading facility, which will be understood to comprise the necessary software and protocols for offering shares for sale, for bidding for shares, and for transferring ownership of shares. However, project stakeholders are bound by additional exchange rules that forbid insider dealing and dealing during closed periods. The trading systems maintain a complete audit of all transactions to prevent fraud.

Assuming that all of the stages of the project are met successfully, then it will proceed to the planned project exit in step S36. In this case the exit plan could be another stock market initial project offering, licensing the project IP, or the outright sale of the business. In any case the shareholders, including the project founders, receive an investment return.

Another alternative is that there is no exit and the shareholders retain their shares in a trading enterprise that continues at the back end of the exchange. Shareholders would then be able to receive dividends and continue to buy or sell shares in the enterprise.

Whatever the reasons for project termination, all of the project's intellectual property is archived on the Exchange in step S40 and is available for further exploitation for the greater benefit of the shareholders.

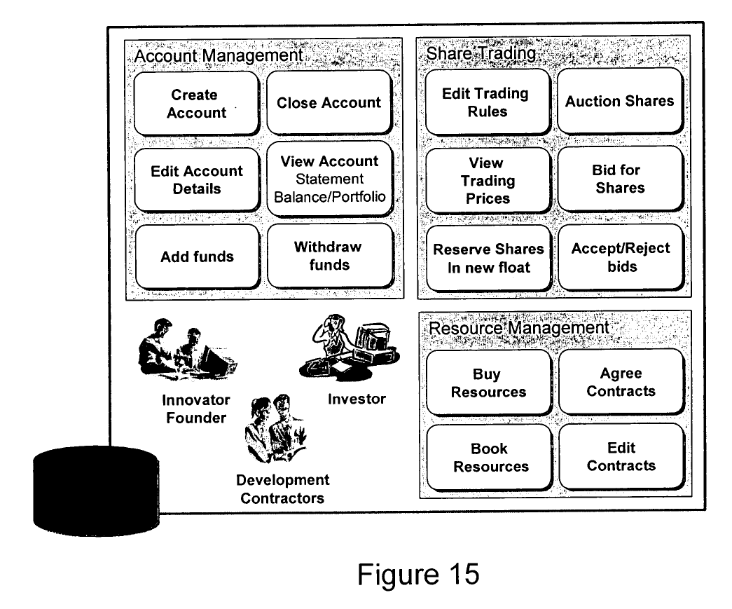

It will be appreciated that the exchange, according to the preferred embodiment of the invention, not only provides a procedure in which project founders can generate revenue, but also provides opportunity for investment. The systems and processes involving the investor or resource provider side of the exchange will now be described in more detail with reference to FIG. 15.

All users of the exchange are preferably provided with individual accounts. A typical interface for an account is shown in FIG. 15. Access to this interface is preferably made through the dedicated web site, using a browser on a personal computer, or a mobile computing devices. However, account instructions or a request for an account balance or status report may also be made through mobile phones (including text messages and GPRS), e-mail (web or client based) and traditional telephony with either human operators or automatic voicemail systems.

As will be understood to the skilled man, it is preferable to provide some sort of security check before an account can be accessed. Biometric checks are therefore preferably used for added security. Assuming technology for biometric testing is readily available, security checks could involve biometric fingerprint or iris scans that are activated during account log-on, cross-checked against stored biometric information within the exchange system or checked against reference biometric information on national identity cards. In simpler implementations, biometric verification could also be performed from the user's voice during phone calls or by keyboard dynamics during input of text information into the browser. These dynamics include monitoring the timing of keyboard strokes, or of letter combinations.

The user interface shown in FIG. 15 includes a number of options for an individual to manage their trading and interaction with the exchange. Accounts management options are provided including functions to create an account, close an account, edit account details, view an account statement or balance portfolio, add funds to an account and withdraw funds from the account. Share trading functions preferably include editing trading rules, auctioning shares, viewing trading prices, bidding for shares, reserving shares in a new float, and accepting or rejecting bids. Lastly, functions for resource management may also be provided, such as buying resources, booking resources, agreeing contracts or editing contracts.

Adding funds or withdrawing funds can be achieved by using credit card/payment service providers such as Paypal or by bank account transfers. To reserve shares in a new project flotation, for example, a user's account funds are committed by the exchange against the reserved shares. If the flotation of the project is successful and fully subscribed then the committed funds are automatically transferred to an exchange account dedicated to the project, for release at the appropriate times. If the flotation is unsuccessful, then the fund commitment is released by the exchange and the funds are available to the user once again.

The auction shares function allows a user to set minimum selling prices (reserves) as in normal auctions for the selling of their shares in a particular project. Preferably no stock brokers or market makers are involved in the exchange system. As a result any commission charges or overheads are kept low. However, there are therefore no guarantees of a share sale.

Furthermore, for users who want to minimise the management effort of their share portfolio, the edit trading rules function allows the definition of automatic trading rules. For instance, the user can stipulate that their shares are automatically auctioned when the share-selling price reaches some preset limit. Sophisticated trading rules can be set for the automatic management of both buying and selling shares. Functions such as review trading prices, bid for shares, accept/reject bids functions are evident and will not be described in more detail here.

The resource management functions allow users to purchase from their account any exchange resources that are for sale, such as investment reports or their membership subscriptions. More sophisticated users such as project founders or innovators can also reserve or purchase not only exchange resources but also the resources offered by third party contractors that are accredited and listed on the exchange. These might be individuals or teams of patent attorneys and engineering contractors, intangibles such as licenses or transfers of listed intellectual property rights or the use of facilities such as manufacturing plants or testing equipment.

The exchange preferably offers a standard contract template for the reservation or purchase of these resources. However, where this is inappropriate the exchange also supports mechanisms for creating, editing, versioning and agreeing contracts. This includes the ability to digitally sign contracts using the public key infrastructure (PKI). A user who opts for e-mail notification of flotations, for example is preferably able to subscribe to the stock by e-mail return of the notification. To make this secure, the system preferably incorporates public key infrastructure, that is digital signing of account instructions by e-mail form.

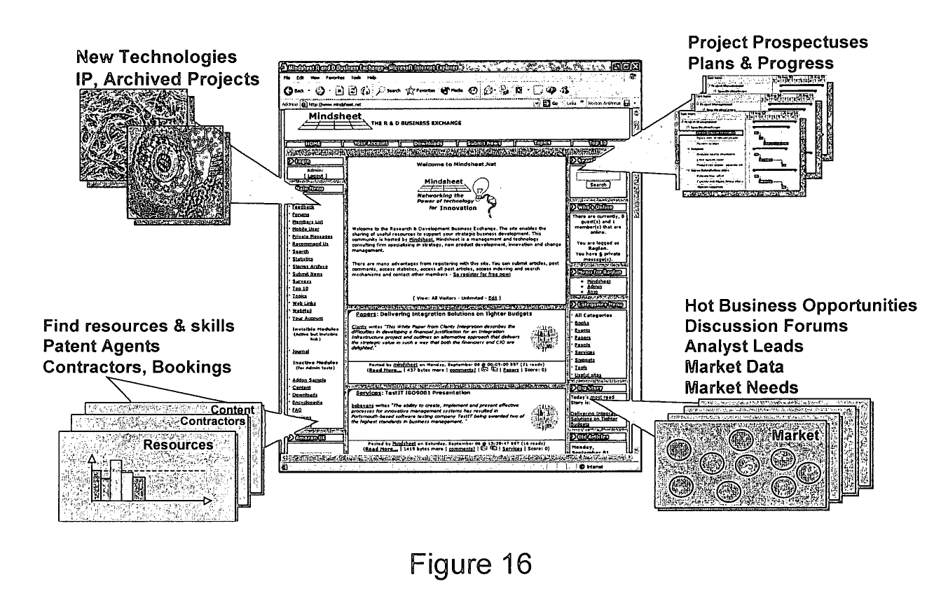

As has been described earlier, all of the above functions are preferably available through a single web site portal, which shall be referred to as the content management system (CMS), forming the heart of the exchange. This allows dissemination and contribution of information for the exchange community. An example format is shown in FIG. 16. The content management system is preferably organised into categories such as market segments and data, resources, projects, processes and technologies. Submissions are preferably queued for editorial approval prior to publication.

The CMS information will be essential for supporting founders during the research and planning stages of their projects. Also, the investors may use it to research potential investments.

Another mechanism provided by the CMS are forums that are classified according to headings or subject themes. Within a forum, customers can post problems and invite founders or innovators to invent solutions. For instance, an ethical theme might highlight the problems of plastic landmines and invite innovators to come up with technological solutions for detecting plastic mines. This may appeal to any special interest communities that develop within the exchange. Furthermore, such communities are likely to be the first investors in flotations of such projects.

The CMS web site may also provide for special interest groups or clubs to be subscription based and receive a first mover advantage in any forthcoming flotation. This may appeal to corporations that want to set a wide tracking filter across a spectrum of technologies as an adjunct to their in-house technology management strategy. Consumer groups could club together and set up surveys that provide feedback on market requirements for founders. Other CMS resources may be linked to other sites and process information instructions to guide users.

Other resources that the CMS preferably provides are information or interest based collections, such as stories, statistics, news, surveys, top ten projects, and notifications of papers or new services. It is also preferred if the CMS interface may be customised for each individual user account.

The discussion so far has been restricted to an exchange for the development of high value technical solutions. However, the exchange can also be used for focusing investment in a number of other areas, such as the process for creating a theatre production or a creative work. The process that a technical or business project must follow is defined by the five stages shown in FIG. 1. For a creative work however, these may not be appropriate, and the preferred system therefore provides process management or editing functions for an authorised manager of the exchange to develop a process framework or edit an existing one. Such a framework would set the goals to be achieved in each of the stages of development, and provide criteria against which to develop the completion of the stage, and the progress of the project.

In summary, the preferred system offers:
a) an enterprise prospectus publication process enabling the inventor to determine a level of interest in a specific new product/technology;
b) an enterprise share reservation system that allows the investor to request shares at an advertised price; and also for that investor to commit funds, that will be returned if the offer is not fully subscribed;
c) a public review process where independent auditors report progress on the start-up enterprise's development process;
d) a secondary market system that allows the investor to buy and/or sell shares during the public review process.
e) an enterprise exit process whereby the investor is able to realise his/her investment.

The preferred system makes use of a number of dedicated processes, including:
a) an auto-concept evaluator; that is to say, a system that allows a start-up to determine whether its product or technology concept is good enough to be considered for marketing to potential investors;
b) an auto-project planner that enables start-ups to put together a plan through a financial modelling tool that determines the end value of the enterprise;
c) a project registration system, where the start-up enterprise inputs all relevant data necessary for approval for marketing shares to the public including technology/product concept, business plan, metrics.
d) a project resourcing system that allows enterprises to source specific capabilities and manpower to help develop the product through the development cycle.
e) a system that provides publicly available data on the progress of start-up enterprises enabling the public to assess the value at any time of such enterprise;
f) a web-based system facilitating information provision and input access from different devices, including, but not limited to computers, PDA's, mobile phones, automated teller machines, airport and aircraft customer-available screens, televisions;
g) a browser system whereby an investor or analyst or member of the public can view prospectuses, track records of project players, analyst reports, financial instruments, prices and market data;
h) a secondary market system, that allows shareholders to offer shares for sale at a specific price and for investors to buy shares within a counter arrangement.

In addition to providing a vehicle for investment returns, therefore, the preferred embodiment of the invention also provides a regulated and secure framework in which new ventures and business start-ups can bid for funding, receive support and develop.

It will be appreciated therefore that the preferred embodiment of the invention provides numerous economic advantages such as the development of new technologies and enterprises, as well as investment returns. At the conclusion of stage S8, the project venture is able to determine which strategy to adopt in order to maximise its value, including such strategies as sale to a third party, initial public offering (IPO) on other stock exchanges, and product licenses.

1. A system for investing in projects seeking funding, comprising a server having a share allocation facility for allocating shares to said projects; and a share trading facility for buying and selling shares in one or more of said projects.

2. The system according to claim 1, comprising a graphical user interface for displaying information about a project, said information including share price information.

3. The system according to claim 2, wherein the graphical user interface has a facility for new projects seeking funding to submit a funding application to the system.

4. The system according to claim 3, comprising input means for entering, as part of a funding application, the development goals of said project, as well as the estimated total cost of achieving those goals, and the estimated returns if those goals are achieved.

5. The system according to claim 4, wherein said share allocation facility allocates shares in a project seeking funding in dependence on said total estimated costs.

6. The system according to claim 5, wherein said share allocation facility comprises means for investors to reserve shares in said project.

7. The system according to claim 6, wherein said share allocation facility is operable to commit funding from investors to purchase shares only when a pre-determined of shares have been reserved.

8. The system according to claim 4, wherein the input means require that the development goals of the project are divided into one or more stages, with the costs and obstacles to be met to complete the stage given for each.

9. The system according to claim 8, wherein the share allocation facility is operable to release to the project, from the funding received from investors, only sufficient funding to fund the present stage of the development process.

10. The system according to claim 1, wherein the share allocation facility is operable to return any funding not yet made available to said project to the investors, if the project does not achieve the goals of the present stage of development.

11. The system according to claim 10, comprising an auditor database, and means for allocating an auditor to a project.

12. The system according to claim 11, comprising means for an auditor to publish the results of an audit of at least one of the project stages.

13. The system according to claim 3, wherein the system comprises a calculator for scoring said funding application from a project seeking funding, and for giving an output.

14. The system according to claim 13, wherein in dependence on said output the funding application is rejected, or is passed.

15. The system according to claim 14, comprising means for transmitting said funding application, if it is passed, to a reviewer who reviews the funding application before passing it to the share allocation facility.

16. The system according to claim 15, comprising a database of resource providers, and input means for entering, as part of a funding application, requests for resources that are required in order to achieve said development goals.

17. The system according to claim 16, comprising transmission means for transmitting requests for resources to resource providers.

18. The system according to claim 2, wherein the graphical user interface comprises a facility for potential investors to submit tenders for projects.

19. The system according to claim 18, comprising a database of potential project developers, and means for transmitting said tenders for projects to said potential project developers.

20. In an on-line trading system, the improvement comprising means for allocating shares to projects seeking funding, and means for trading shares in said projects.

21. An electronic trading system comprising a facility for trading shares in pre-trading enterprises.

22. A method of attracting investment in projects seeking funding comprising the steps of:
a) inviting the project seeking funding to submit a project proposal detailing the project development process and the estimated total costs of said project development;
b) creating shares in the project seeking funding to generate funding for said estimated costs;
c) selling said shares in the project seeking funding to investors; and
d) transferring at least some of the funding generated in said selling step to the project seeking finding.

23. The method according to claim 23, comprising publishing information about a project seeking funding, said information including share price information.

24. The method according to claim 22, wherein in the inviting step, the project proposal submitted by the said project is required to specify one or more development stages, and for each development stage one or more goals.

25. The method according to claim 24, wherein in the inviting step, the project proposal submitted by the project seeking funding is required to specify the estimated returns if those goals are achieved.

26. The method according to claim 25, wherein in the transferring step, sufficient funds are transferred to the project seeking funding, from those generated in said selling step to fund only a single stage of the development process.

27. The method according to claim 26, comprising the step of auditing a development stage in the development process of the said project, and publishing the audit results.

28. The method according to claim 27, comprising the step of transferring funding to fund a subsequent stage in the development process in dependence on said audit results.

29. The method according to claim 28, comprising returning any funding not yet made available to the project seeking funding to the investors, if the project seeking funding does not achieve the goals of the present stage of development.

30. The method according to claim 22, wherein the transferring step only occurs if a pre-determined number of shares allocated to the project seeking funding have been sold.

31. The method according to claim 30, wherein the transferring step only occurs if all of the shares allocated to the project seeking funding have been sold.

32. The method according to claim 23, comprising providing a facility for the project seeking funding to score their project proposal, the facility giving an output.

33. The method according to claim 32, comprising rejecting or passing the funding application in dependence on said output.

34. The method according to claim 33, comprising inviting the project seeking funding to meet with a funding advisor if the project proposal is passed.

35. The method according to claim 23, comprising publishing the project proposal of said project seeking funding.

36. The method according to claim 22, wherein said selling step comprises inviting investors to reserve shares in said project seeking funding.

37. The method according to claim 36, comprising the step of committing funding from investors to purchase shares only when a pre-determined of shares have been reserved.

38. The method according to claim 22, comprising the step of providing to a project seeking funding information regarding resource providers who provide resources which assist in the project development process.

39. A stock exchange for trading shares in a project seeking funding, comprising:
an investor interface for publicly allocating, buying and selling shares in a project seeking funding;
a structured development process having one or more development stages, each stage having a goal, which the project seeking funding should achieve before entering the next stage;
a public auditing process for reviewing the progress of a project and for releasing auditing results to the investor interface such that decisions about share trading can be based on said auditing results.

40. A method of facilitating investment in a project seeking funding, comprising the steps of:
providing an investor interface for publicly allocating, buying and selling shares in a project seeking funding;
requiring the project seeking funding to follow a structured development process having one or more development stages, each stage having a goal, which the project seeking funding should achieve before entering the next stage;
auditing the progress of the project seeking funding; and
releasing the results of the auditing step to the investor interface such that decisions about share trading can be based on the auditing results.

41. A method of screening applications from project developers, comprising the steps of:
a) providing a graphical user-interface inviting a project developer to submit a project proposal for the development of a product;
b) requesting via said graphical user-interface that the project developer input information describing the product's strengths and weaknesses compared to those of competitors;
c) determining an overall score for said project proposal based on the input in step b);
d) comparing the score with a pre-determined threshold; and
e) on the basis of the comparison of said score with said pre-determined threshold, rejecting the application, or inviting the project developer to a subsequent stage of the application process.

42. The method according to claim 41, wherein the graphical user interface invites the project developer to indicate the extent of searching that has been conducted to determine whether the project proposal is new or not.

43. The method according to claim 41, wherein the graphical user interface invites the project developer to indicate one or more of: an idea description, a unique selling proposition, a prime technology for use in the project, the prime market segment, additional factors that might affect the market, the annual size of the market, and the annual growth or shrinkage of the market.

44. The method according to claim 41, wherein the graphical user interface requires the project developer to enter the key market requirements, and give a score to the project proposal for each of the requirements.

45. The method according to claim 44, wherein the graphical user interface requires the project developer to give a score to at least one competing concept.

46. The method according to claim 45, comprising calculating a total score for the project proposal based on the scores entered by the project developer for the competing concept and for the project proposal.

47. The method according to claim 46, wherein the graphical user interface requires the project developer to enter information about the costs of developing the project proposal.

48. The method according to claim 47, wherein the graphical user interface requires the project developer to enter information about the likely return for the project.

49. The method according to claim 47, comprising calculating an estimated projected value for the project, and based on the calculated estimate plan rejecting the application, or inviting the project developer to a subsequent stage of the application process.

50. The method according to claim 41 wherein, the project proposal contains an application for funding.

51. A method of funding a project developer, comprising the steps of:
inviting a project developer to submit a project proposal, the proposal detailing project development stages and, for each project development stage, one or more goals and the estimated cost of achieving those goals;
generating funding for the project developer by selling shares in the project, the total initial value of the shares being sufficient to cover the total estimated costs;
once the funding raised by selling shares is sufficient to cover said total estimated costs:
releasing sufficient funding to the project developer to fund the first development stage only;
monitoring the progress of the project developer, and releasing sufficient funding to the project developer to fund the second stage based on the progress of the project.

52. The method according to claim 51, wherein the funding is released if the project developer is found to meet the goals of the first stage of the project.

53. The method according to claim 51, wherein the funding is not released if the project developer is found not to have met the goals of the first stage of the project.

54. The method according to claim 53, wherein any funding not released is returned to those who bought shares in the project.

55. The method according to claim 51, comprising the step of publishing the results of the monitoring step.

56. The method according to claim 55, comprising providing a facility for buying and selling shares in the project during the development process.

57. A method of facilitating investment in a pre-trading enterprise, comprising the steps of:
a) requiring the pre-trading enterprise to submit a project proposal, the proposal detailing project development stages and for each project development stage one or more goals, the estimated cost of achieving those goals, as well as any predicted obstacles in the development process associated with each development stage, and the likely costs of overcoming each of the obstacles if encountered;
b) presenting to investors the possible outcomes of each development stage assuming that each of said obstacles is met or is not met, with the associated likely financial return of each development stage;
c) receiving investment instructions from said investors;
d) allocating shares in a pre-trading enterprise to investors based on said investment instructions.

58. A method of facilitating investment in a pre-trading enterprise, comprising the steps of:
a) inviting a pre-trading enterprise to submit a project proposal, the proposal detailing project development stages and, for each project development stage, one or more goals and the estimated cost of achieving those goals;
b) allocating shares to the project, the total initial value of the shares being sufficient to cover the total estimated costs;
c) receiving instructions from investors to reserve shares in the project;
d) committing funds from the investors to the project in return for shares, only when a predetermined number of said shares to said project have been reserved.

59. A computer software product comprising computer readable program code, which when executed on a computer causes the computer to perform the steps of claim 22.

60. A graphical user interface for screening funding applications from project developers, comprising:
a) a graphical user-interface inviting a project developer to submit a project proposal for the development of a product, the graphical user interface presenting input means for the project developer to input information including at least an assessment of the market in which the subject of the project proposal is to compete.
b) a calculator for determining an overall score of said project proposal based on the input by the project developer;
c) a comparator for comparing the score with a predetermined threshold; and
d) judgement means for, on the basis of the comparison of said score with said pre-determined threshold, rejecting the application, or inviting the project developer to a subsequent stage of the application process.

61. A computer software product comprising computer readable program code, which when executed on a computer causes the computer to perform the steps of claim 40.

62. A computer software product comprising computer readable program code, which when executed on a computer causes the computer to perform the steps of claim 41.

63. A computer software product comprising computer readable program code, which when executed on a computer causes the computer to perform the steps of claim 51.

64. A computer software product comprising computer readable program code, which when executed on a computer causes the computer to perform the steps of claim 57.

65. A computer software product comprising computer readable program code, which when executed on a computer causes the computer to perform the steps of claim 58.
